(19) United States
(12) Patent Application Publication
(10) Pub. No.: US 2008/0209379 A1
(43) Pub. Date: Aug. 28, 2008

(54) Method of designing semiconductor integrated circuit, design device, and CAD program

(75) Inventor: Tsutomu Nakamori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 12/005,616

(22) Filed: Dec. 28, 2007

(30) Foreign Application Priority Data
Feb. 23, 2007 (JP) 2007-043960

(51) Int. Cl. G06F 17/50

(52) U.S. Cl. 716/10

(57) ABSTRACT

A semiconductor integrated circuit design device capable of carrying out design by evaluating a crosstalk between blocks has been disclosed. The integrated circuit design device is adapted to design a semiconductor integrated circuit having a plurality of blocks and comprises a virtual noise source setting PORTION that sets a virtual noise source at a neighboring boundary with a neighboring block of each block, a block design PORTION that carries out design of each block while taking into consideration influence from the virtual noise source, and an assembly design PORTION that assembles the plurality of the designed hierarchical blocks.

### CROSS-REFERENCE TO RELATED APPLICATION

This application is based upon and claims priority from Japanese Patent Application No. 2007-043960, filed Feb. 23, 2007, the entire contents of which are incorporated herein by reference.

### BACKGROUND OF THE INVENTION

This application relates to a method of designing a semiconductor integrated circuit, a design device, and a CAD program.

The scale of mask design of a large scale semiconductor integrated circuit (LSI) tends to increase year by year and the time required for mask design also increases. Recently, many functions are incorporated in one LSI and the time required for mask design increases. It is therefore necessary to reduce the lead time from the commencement of design to the shipment of product (LSI), and as a result, instead of handling all design data together, design is carried out with a divided “(hierarchical) block” for each function and thus the time required for completing the design is reduced. Such a design method is called a hierarchical design or block design.

FIG. 1A is a diagram explaining the hierarchical design. As shown in FIG. 1A, when an LSI 10 is designed, a block (BLK1) 12 and a block (BLK2) 13 are designed as one functional block, and the remaining portion (BLKA) 11 of LSI 10 excluding blocks 12, 13 are designed separately. When the design of each block is completed, BLKA, BLK1, and BLK2 are assembled and thus the design of the LSI 10 is completed. The design of each block is carried out after a space for each block and input/output signals between blocks are determined.

FIG. 1B shows a hierarchical structure of the above blocks. The whole LSI including portion 11, but excluding block (BLK1) 12 and block (BLK2) 13 is represented as a top hierarchy (BLKA) 10, and BLK1 and BLK2 are represented as being included therein. An example is shown, in which the top hierarchy (BLKA) 10 includes BLK1 and BLK2 in the same hierarchy, however, the number of blocks is arbitrary and the number of hierarchies may be three or more.

FIG. 2 is a diagram showing a hierarchical design flow. As shown schematically, a floor plan 21 for determining the arrangement of all of the functional portions of an LSI is made based on a net list 20, which is logic design data, and the entire arrangement is determined. Then, hierarchy division 22 for determining portions for which design is carried out for each block is carried out. In hierarchy division 22, interface items required for designing each block, such as the space and position of each block, input/output signals between blocks, etc., are determined.

Then, top hierarchy design 23, design 24 of block 1, and design 25 of block 2 are carried out at the same time. Due to this, the design time can be reduced compare to the case where the top hierarchy design 23, the design 24 of block 1, and the design 25 of block 2 are carried out sequentially.

When the top hierarchy design 23, the design 24 of block 1, and the design 25 of block 2 are completed, hierarchy assembly 26 for integrating the blocks is carried out. Then, various analyses 27 are carried out for the assembled LSI. One of the analyses is a crosstalk analysis and when an occurrence of crosstalk error 28 is determined from the result of analysis, the top hierarchy design 23, the design 24 of block 1, and the design 25 of block 2 are carried out again. Although it is not necessary to redesign the whole LSI, but redesign only the portions where the crosstalk error is determined to occur. However, if there is no sufficient margin for design, it is likely that other portions need to be modified in order to modify the design so that no crosstalk error will occur, and in some cases, this may lead to a large-scale redesign.

As describe above, in hierarchy division 22, the interface items necessary for designing each block are determined which is briefly explained below. Because each block does not operate independently of another, input/output of signals to/from other blocks are necessary, and therefore, the interface item of the input/output signal is determined in advance. When designing each block, it is desirable to complete design within the block while observing the interface items and not affecting other blocks. In other words, when designing each block, as long as the interface items are observed, it is possible to carry out the design on the assumption that other blocks do not exist and there is no interaction between blocks. However, other blocks may be affected.

FIG. 3A and FIG. 3B are diagrams explaining such a case. When a need arises to provide a wire 31 that extends vertically in a block (hierarchy) having a block 30 internally, wire 31 is provided so that it bypasses block 30 in order to avoid influence on other blocks (in this case, block 30), and if done so, the design of block 30 is not affected. However, there may be a case where such routing of wire 31 in FIG. 3A is not accepted because the routing distance is longer than that in a beeline and there may be a delay in time, etc. In such a case, wire 31 is arranged so that it passes over block 30, which is another block, as shown in FIG. 3B. This is called a feedthrough.

When feedthrough is carried out, a space in which wire 31 is provided is required in the block 30 over which the wire 31 passes, and at the same time, the block 30 is affected by a crosstalk resulting from the wire 31. To cope with this, when feedthrough is carried out, measures, such as that the wire is caused to pass through a layer different from the signal wire layer in the block, are taken.

FIG. 4A and FIG. 4B are diagrams showing an example of a measure against the feedthrough. In FIG. 4A, a VDD 33 and a VSS 34 are arranged in a power source wire layer and a signal wire 35 is arranged in a block in a layer thereunder. A feedthrough wire 32 is arranged over the power source wire layer and shield wires 36, 37 are arranged on both sides of the wire 32. Due to this, the influence of the feedthrough wire 32 on the block 30 is reduced. FIG. 4B is a top view of a wiring structure in FIG. 4A.

FIG. SA and FIG. 5B are diagrams explaining a crosstalk error. As shown in FIG. 5A, when two signal lines 41, 42 extend in parallel to each other, a parasitic capacitance 43 is formed between the signal lines 41 and 42. As shown in FIG. 5B, when the level of signal 1 of the signal line 41 changes, signal 2 of the signal line 42 is affected by the change in the level of the signal 1 due to parasitic capacitance and noise is produced. If the noise level is high, it will be determined that signal 2 has changed and an erroneous operation (error) occurs. This is a crosstalk error. The longer the parallelly extending signal lines are, the larger is the parasitic capacitance 43 between the signal lines 41 and 42, and the noise level produced is higher.

As described above, the design of each block is carried out on the assumption that there is no interaction between blocks as long as the interface items are observed. However, if a long wire that extends exists at the boundary between neighboring blocks, a crosstalk error will occur. FIG. 6 is a diagram explaining this.

As shown in FIG. 6, when a signal line 44 that extends along the boundary with the block 30 is provided in the block (hierarchy) having the block 30 internally, if a signal line 45 that extends in parallel to the signal line 44 is provided in the block 30, a crosstalk error will occur between the signal lines 44 and 45. There is, as a matter of course, a case where such a signal line 44 that extends along the boundary is not provided, and this applies to most cases; however, if it is determined that a crosstalk error will occur due to the provision of such a signal line 44, redesign is required.

Such redesign will cause an unexpected increase in design time and a problem of delay in delivery may occur. In order to avoid such a situation without fail, a shield wire is arranged around the block.

FIG. 7A and FIG. 7B are diagrams explaining a shield wire for preventing a crosstalk error with a neighboring block. In FIG. 7A, a signal line 51 extending in a first direction is arranged in a first signal wire layer, a signal line 53 extending in a second direction is arranged in a second signal wire layer, and a signal line 52 extending in the first direction is arranged in a third signal wire layer. Then, shield wires are arranged around the peripheral boundary. Specifically, on both ends of the first signal wire layer, two shield wires 54, 55 are arranged, on both ends of the second signal wire layer, two shield wires 56 are arranged, and on both ends of the third signal wire layer, two shield wires 57, 58 are arranged.

FIG. 7B is a top view of FIG. 7A and the shield wires are arranged at the boundary on the periphery of the block 30.

FIG. 8 shows a flow of conventional mask design. In step 61, blocks are cut out, in step 62 shields are created, in step 63, instances (circuit elements) are arranged and wiring is carried out, in step 64 a crosstalk analysis in the block is carried out, in step S65, the blocks are assembled, in step 66, the crosstalk analysis on the whole is carried out, and in step 67, a manual modification is carried out for insufficient parts. If robust shields are arranged in step 62, it is possible to prevent the manual modification in step 67 from occurring.

Conventional design techniques are described in, for example, Japanese Unexamined Patent Publication (Kokai) No. H11-54628, Japanese Unexamined Patent Publication (Kokai) No. H6-180733, Japanese Unexamined Patent Publication (Kokai) No. 2000-21988, etc.

As described above, in the conventional mask design of an LSI having a plurality of blocks, because the design of each block is carried out independently, the boundary with other neighboring blocks cannot be taken into consideration and no crosstalk analysis is carried out for those including the boundary with other neighboring blocks. Because of this, if the design of blocks is carried out without any measures taken, a problem arises when a crosstalk analysis on the whole is carried out after assembly, and redesign (manual modification) is required.

In order to prevent such a problem in a crosstalk analysis when a plurality of designed blocks are assembled, a measure is taken, in which the shield wires are arranged at the boundary around each block, as described above. However, such a measure brings about a problem in that the number of processes is increased accordingly and the space each block can use is reduced because of the shield wires arranged at the boundary around each block. In other words, excessive design is carried out to prevent redesign.

### SUMMARY

The embodiment makes it possible to evaluate a crosstalk between blocks properly and carry out design properly.

The embodiment is characterized in that a virtual noise source is set outside the blocks, i.e., at the boundary with neighboring blocks and the design of each block is carried out while taking the influence from the virtual noise source into consideration, i.e., by carrying out a crosstalk analysis.

The position and noise strength of the virtual noise source is set in advance from the outside by a designer.

If necessary, it is possible to change design data in order to prevent a crosstalk error from occurring in accordance with the result of an analysis of a wire crosstalk in each block.

As described above, conventionally, noise sources outside blocks are not at all taken into consideration in designing, and therefore, a crosstalk error occurs when a plurality of blocks are assembled and a manual modification (redesign) is required, or shields are formed around the blocks to avoid the influence of noise sources outside the blocks, and therefore, spaces are wasted. In contrast to this, according to the embodiment, a virtual noise source is set outside blocks and design is carried out while taking it into consideration, and therefore, it is made possible to design more properly with a crosstalk being taken into consideration.

According to the embodiment, it is possible to avoid a manual modification (redesign) when a plurality of blocks are assembled and at the same time, because unnecessary shields are not provided, it is possible to more properly design by efficiently utilizing spaces.

### BRIEF DESCRIPTION OF THE DRAWINGS

The features and advantages of the embodiment will be more clearly understood from the following description taken in conjunction with accompanying drawings, in which:

FIG. 1A and FIG. 1B are diagrams explaining hierarchical design;

FIG. 2 shows a flow of hierarchical design;

FIG. 3A and FIG. 3B are diagrams explaining a feedthrough;

FIG. 4A and FIG. 4B show a configuration example of a shield wire (power source);

FIG. 5A and FIG. 5B are diagrams explaining a crosstalk;

FIG. 6 is a diagram explaining a crosstalk between blocks;

FIG. 7A and FIG. 7B show a configuration example of a shield wire (signal wire);

FIG. 8 shows a conventional design flow;

FIG. 9 is a block diagram showing a configuration of a design device according to the embodiment;

FIG. 10 shows a design flow according to the embodiment;

FIG. 11A and FIG. 11B show an example of a virtual noise source according to the embodiment; and

FIG. 12A and FIG. 12B are diagrams explaining an effect of the embodiment.

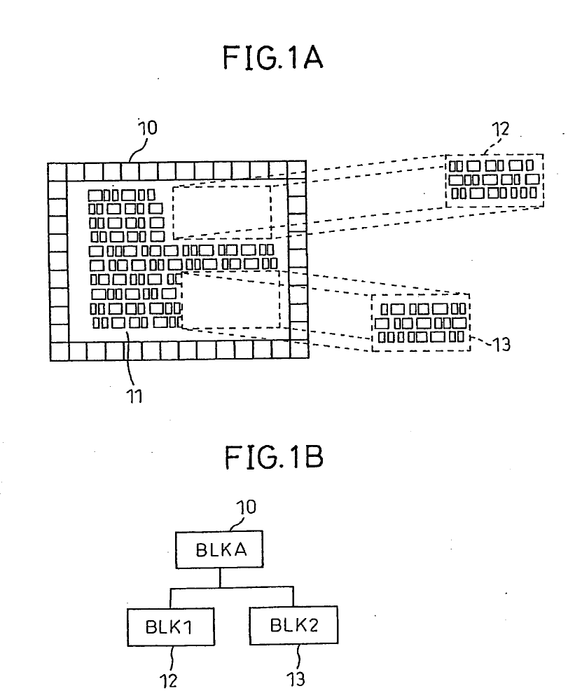

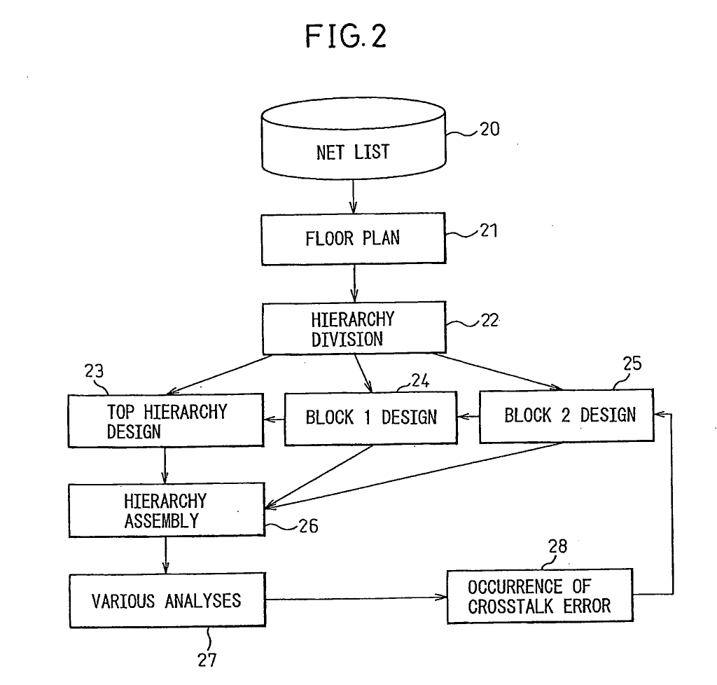

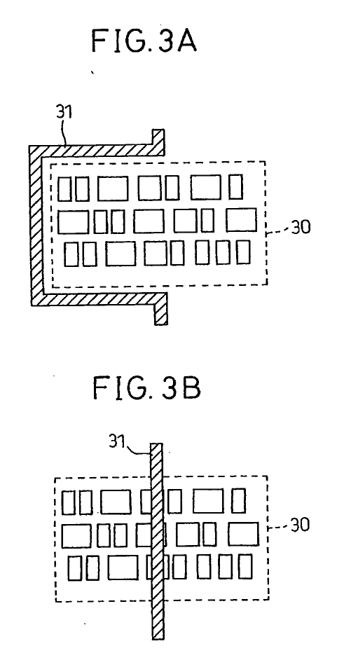

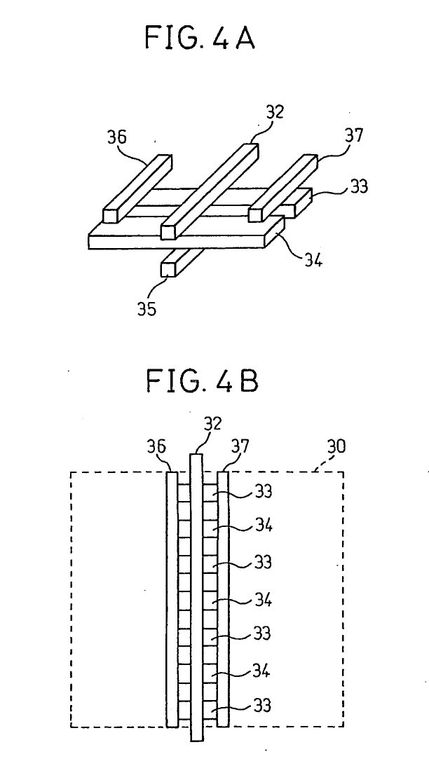

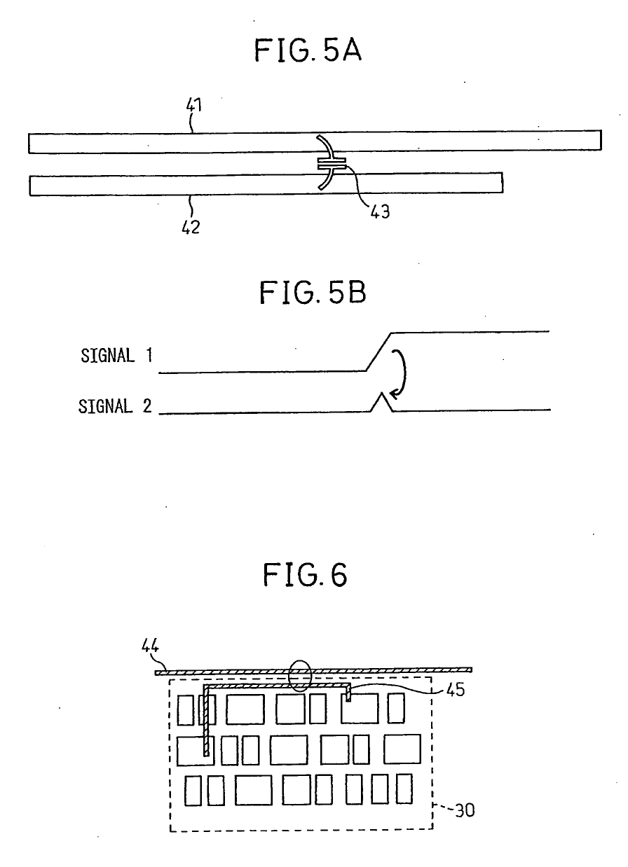

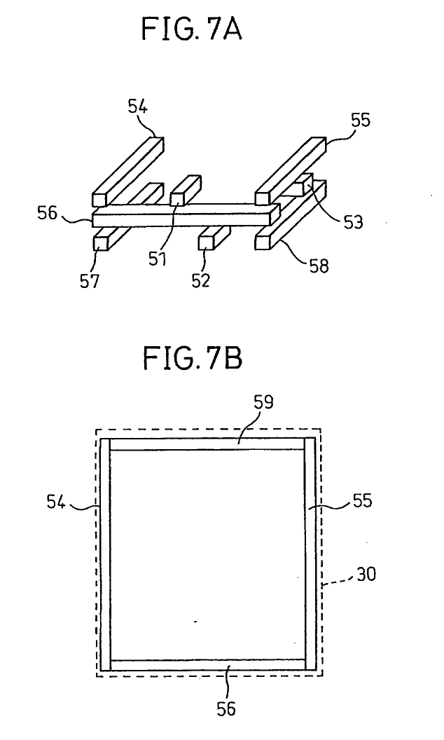

### DESCRIPTION OF THE PREFERRED EMBODIMENTS

The embodiment is realized in the form of an LSI mask design CAD device and relates to a design method that utilizes a CAD device, a CAD device, i.e., a mask design device, adapted to be capable of carrying out the method of the embodiment, and a program installed in a CAD device so that a verification method of the embodiment is carried out.

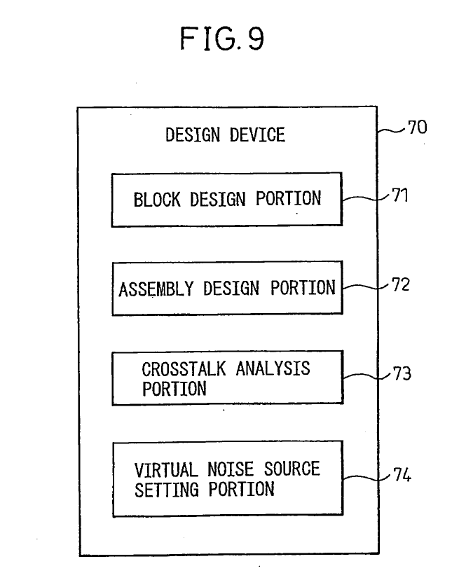

FIG. 9 is a block diagram showing a configuration of a mask design device of the embodiment. As shown schematically, a mask design device 70 comprises a block design portion 71, an assembly design PORTION 72, a crosstalk analysis PORTION 73, and a virtual noise setting portion 74 and the crosstalk analysis portion 73 carries out a crosstalk analysis while taking into consideration a virtual noise set by the virtual noise setting PORTION 74.

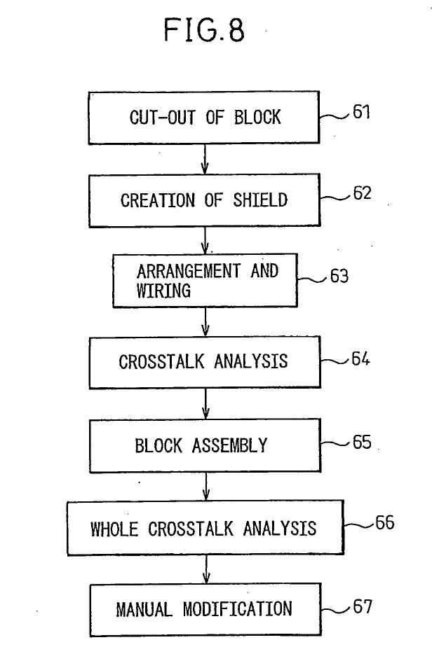

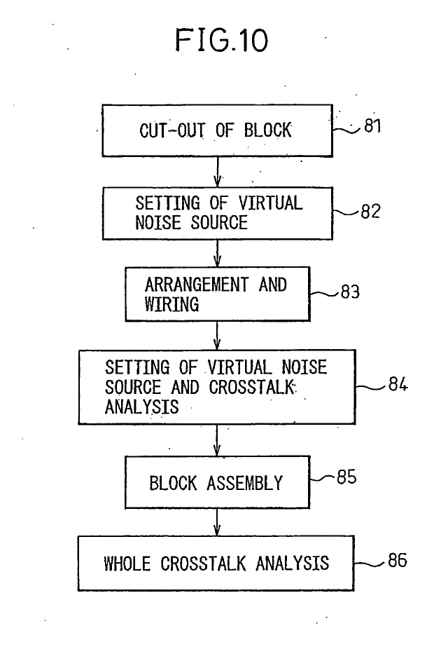

FIG. 10 is a design flow diagram of a mask design method of the embodiment. In step 81, blocks are cut out, in step 82, a virtual noise source is set outside each block, in step 83, the arrangement and wiring of instances (circuit elements) are carried out, in step 84, a crosstalk analysis in each block is carried out while taking into consideration the noise from the virtual noise source outside each block, in step 85, the blocks are assembled, and in step 86, a crosstalk analysis on the whole is carried out for confirmation. According to the embodiment, it is not necessary to carry out a manual modification as in the conventional example in FIG. 8. An operator (designer) sets the position and noise strength of the virtual noise source.

A specific example of the setting of a virtual noise source is explained below.

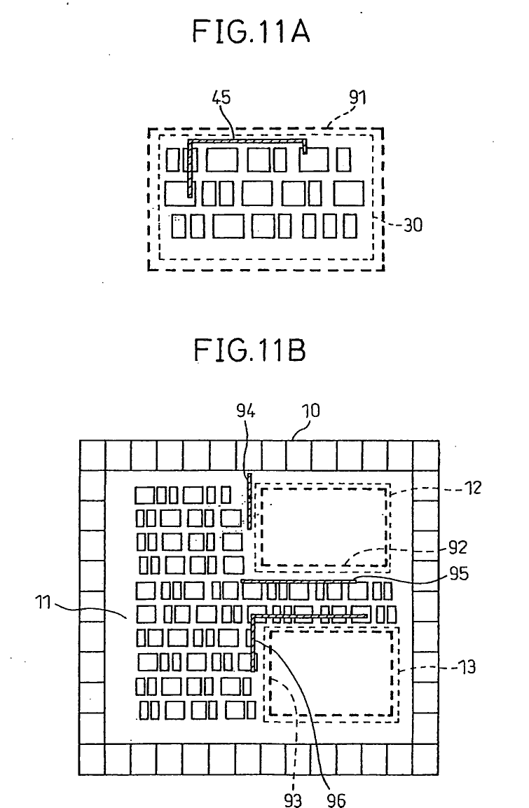

FIG. 11A and FIG. 11B are diagrams showing an example of a virtual noise source. FIG. 11A shows a case where a virtual noise source 91 is set around a block 30. In FIG. 11A, the virtual noise source 91 is provided throughout around the block 30, however, it may be partially provided. In addition, the strength of the virtual noise source 91 is set arbitrarily.

When a signal wire 45 extending along the periphery in the block 30 is provided, as shown in FIG. 11A, a crosstalk analysis with the virtual noise source 91 is carried out and routing is designed so as to prevent a crosstalk error form occurring, i.e., to prevent the wire from becoming too long.

FIG. 11B shows a case where a (hierarchical) block 11 of an LSI 10 includes two blocks 12, 13. When designing the block 11, virtual noise sources 92, 93 are set in the blocks 12, 13. Similar to the above, the positions and strengths of the virtual noise sources 92, 93 are set arbitrarily. When designing the block 11, a crosstalk analysis is carried out on the assumption that the virtual noise sources 92, 93 are present so that a crosstalk error is prevented from occurring. For example, signal wires 94, 95 that extend along the virtual noise source 92 and a signal wire 96 that extends along the virtual noise source 93 are designed to have a length that does not cause a crosstalk error.

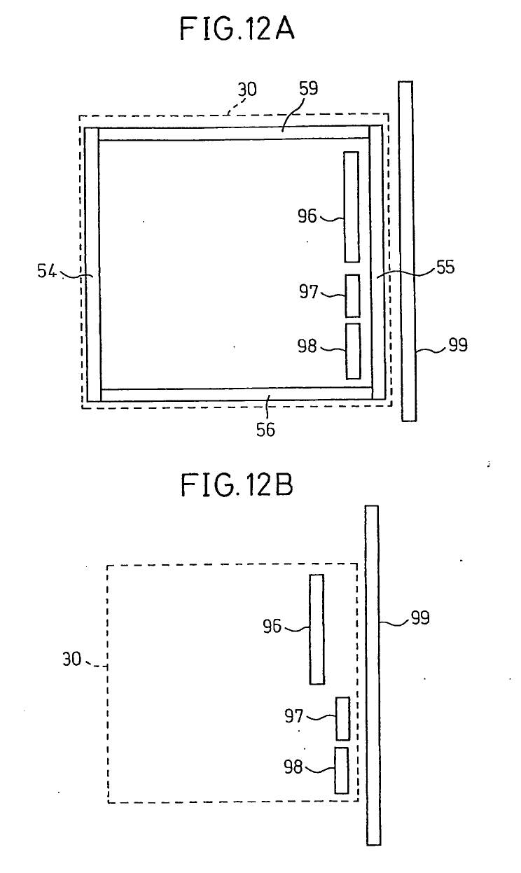

FIG. 12A and FIG. 12B are diagrams explaining an example of an effect of the embodiment. FIG. 12A is a diagram explaining the conventional example and in this example, shield 54, 55, 56, 59 are formed around the block 30 in order to prevent the influence of the noise source outside the block 30. Because of this, a large part of the block 30 is used for the shields.

It is assumed that a long signal wire 99 that extends outside the right-hand side of the block 30 is provided and signal wires 96, 97, 98 are provided along the shield 55 on the right-hand side within the block 30, as shown in FIG. 12A. Because the shield 55 is provided, it is unlikely that a crosstalk error with the signal wire 99 on the outside occurs in the signal wires 96, 97, 98.

In contrast to this, in the embodiment, the long extending signal wire 99 is set as a virtual noise source on the right-hand side of the block 30, as shown in FIG. 12B. When the signal wires 96, 97, 98 are provided along the right-hand side edge within the block 30, the signal wire 96 is long, and therefore, it is necessary to set the signal wire 96 distant from the edge as shown schematically because if the signal wire 96 is provided along the edge of the block 30, i.e., close to the signal wire 99, a crosstalk error will occur. In contrast to this, the signal wires 97, 98 are short, and therefore, it is possible to set the signal wires 97, 98 close to the edge as shown schematically because a crosstalk error will not occur even if the signal wires 97, 98 are provided along the edge of the block 30, i.e., close to the signal wire 99. In addition, it is also possible to provide a short shield between the signal wire 96 and the edge in FIG. 12B.

As obvious from a comparison between FIG. 12A and FIG. 12B, according to the embodiment, it is not likely that an unnecessary shield be provided, and therefore, the space of the block can be used effectively and there will be no need to redesign.

The position and the strength of the virtual noise source can be set arbitrarily. For example, conditions, such as that the length of a signal wire that extends along an edge with its neighboring block be 30% or less of the edge length etc., are set in advance for a predetermined block, and the predetermined block is designed so as to satisfy the conditions. In this case, when designing a block that neighbors the predetermined block, it is possible to set a smaller virtual noise source in the predetermined block.

The embodiment can be applied to any case as long as a semiconductor integrated circuit is designed by dividing it into blocks.

We claim:

1. A method of designing a semiconductor integrated circuit by designing each of a plurality of the blocks of a semiconductor integrated circuit having the plurality of blocks and assembling the plurality of the designed blocks,
wherein a virtual noise source is set at a neighboring boundary with a neighboring block of each block, and
design of each block is carried out while taking into consideration the influence from the virtual noise source of the neighboring block.

2. The method of designing a semiconductor integrated circuit as set forth in claim 1,
wherein the position and noise strength of the virtual noise source is set in advance by a designer.

3. The method of designing a semiconductor integrated circuit as set forth in claim 1,
wherein a wire crosstalk due to the virtual noise source of the neighboring block is analyzed in each block and design of each block is carried out while taking the result of analysis into consideration.

4. The method of designing a semiconductor integrated circuit as set forth in claim 3,
wherein design data is changed in accordance with the result of analysis of the wire crosstalk in each of the blocks to prevent a crosstalk error from occurring.

5. An integrated circuit design device for designing a semiconductor integrated circuit having a plurality of blocks, comprising:
a virtual noise source setting portion that sets a virtual noise source at a neighboring boundary with a neighboring block of each block;
a block design portion that carries out design of each block while taking into consideration the influence from the virtual noise source; and
an assembly design portion for assembling the plurality of designed hierarchical blocks.

6. The semiconductor integrated circuit design device as set forth in claim 5,
wherein the virtual noise source setting portion sets the position and noise strength of the virtual noise resource based on an input from the outside.

7. The semiconductor integrated circuit design device as set forth in claim 5, further comprising a crosstalk analysis portion that analyzes a wire crosstalk resulting from the virtual noise resource in a neighboring block in each block,
wherein design of each block is carried out while taking the result of analysis into consideration.

8. A CAD program for causing a computer to operate to design a semiconductor integrated circuit by designing each of a plurality of blocks of a semiconductor integrated circuit having the plurality of blocks and then assembling the plurality of the designed blocks, the CAD program causing a computer to operate to:
set a virtual noise resource at a neighboring boundary with a neighboring block of each block; and
design each block while taking into consideration the influence from the virtual noise source of the neighboring block.

9. The CAD program as set forth in claim 8,
wherein the CAD program causes a computer to set the position and noise strength of the virtual noise source input from the outside.

10. The CAD program as set forth in claim 8,
wherein the CAD program causes a computer to analyze a wire crosstalk resulting from the virtual noise source of the neighboring block in each block and to design each block while taking the result of analysis into consideration.
